(19) United States
(12) Patent Application Publication
(10) Pub. No.: US 2024/0186493 A1
(43) Pub. Date: Jun. 6, 2024

(54) MANUFACTURING OF AN ELECTRODE LAMINATE WITH A TREATED CARRIER FOIL

(71) Applicant: Solid Power Operating, Inc., Louisville, CO (US)

(72) Inventors: Brandon KELLY, Longmont, CO (US); Uday KASAVAJJULA, Superior, CO (US); A. YANG, Erie, CO (US)

(21) Appl. No.: 18/527,059

(22) Filed: Dec. 1, 2023

Related U.S. Application Data
(60) Provisional application No. 63/429,383, filed on Dec. 1, 2022.

(51) Int. Cl. H01M 4/36; H01M 4/04; H01M 4/38; H01M 4/66

(52) U.S. Cl. CPC H01M 4/366; H01M 4/0435; H01M 4/382; H01M 4/386; H01M 4/667

(57) ABSTRACT

Aspects of the present disclosure involve utilizing layers, such as an outer carrier foil layer, that provide a surface energy sufficient to prevent separation of the layers of the stack during lamination while allowing for the proper densification of the solid-electrolyte separator layer. In one particular example, a Corona-treated or carbon coated outer foil layer may be used during manufacturing of the electrode stack that provides a sufficient surface energy to adhere to the solid-electrolyte separator layer during the lamination process, while allowing for subsequent peeling of the Corona-treated outer foil from the electrode stack after densification without damaging the remaining layers of the stack. The electrode laminate discussed herein may be utilized in any type of battery or electrochemical cell, including solid, semi-solid, or liquid-based batteries.

### CROSS-REFERENCE TO RELATED APPLICATION

This application is related to and claims priority under 35 U.S.C. § 119(e) from U.S. Patent Application No. 63/429,383, filed Dec. 1, 2022, titled “Manufacturing of an Electrode Laminate With a Treated Carrier Foil,” the entire contents of which is incorporated herein by reference for all purposes.

### TECHNICAL FIELD

Various embodiments described herein relate to the field of solid-electrolyte containing primary and secondary electrochemical cells, electrodes, and electrode materials, and the corresponding methods of making and using the same.

### Background and Introduction

The evolution of hybrid and electric automobiles and other battery powered vehicles, and more generally numerous battery-powered devices, is creating needs for battery technologies with improved reliability, capacity, thermal characteristics, lifetime, and recharge performance, among other things. Currently, although lithium-based and other solid-state battery technologies offer potential improvements in safety, packaging efficiency, and enable new high-energy chemistries as compared to other types of batteries, improvements in lithium-based and other solid-state battery technologies are needed, including advances in high volume production and cost reductions to the same.

It is with these observations in mind, among others, that various aspects of the present disclosure were conceived.

### SUMMARY

One aspect of the present disclosure relates to a method for manufacturing a battery electrode. The method may include the operations of coating an electrode layer onto a current collector foil, drying the coated electrode layer, layering a treated carrier foil having a surface energy adjacent to the dried electrode layer, and densifying the electrode layer by applying a densifying pressure to the dried electrode layer, wherein the surface energy adhering the dried electrode layer to the treated carrier foil retains the adherence of the dried electrode layer to the treated carrier foil following densification.

Another method for manufacturing a battery electrode may include the operations of casting a solid-state electrolyte (SSE) layer onto a treated carrier foil, the treated carrier foil comprising a surface energy for adhering the SSE layer to the treated carrier foil, layering a conductive layer adjacent to the first SSE layer to form an electrode stack, and densifying the SSE layer by applying a densifying pressure to the SSE layer, wherein the surface energy retains the adherence of the SSE layer to the treated carrier foil following the densifying of the electrode stack.

Another aspect of the present disclosure relates to a method for a laminated electrode. The method may include the operations of layering a first side of a solid-state electrolyte (SSE) layer adjacent to a conductive electrode as an electrode stack, wherein the SSE layer is cast onto a carrier foil on a second side opposite the first side and laminating the SSE layer to the conductive electrode by applying a laminating pressure to the electrode stack. The method may also include removing the carrier foil from the second side of the SSE layer, layering the second side of the SSE layer with a treated carrier foil comprising a first surface energy for adhering the SSE layer to the treated carrier foil, and densifying the SSE layer by applying a densifying pressure to the electrode stack, wherein the densifying pressure is greater than the laminating pressure.

Yet another aspect of the present disclosure relates to a system for manufacturing a battery electrode. The system may comprise a pressing device densifying, through an applied pressure, a solid-state electrolyte (SSE) layer of an electrode stack, the electrode stack comprising the SSE layer and a treated carrier foil comprising a first surface energy for adhering the SSE layer to the treated carrier foil, wherein the first surface energy retains the adherence of the SSE layer to the treated carrier foil following the pressing of the electrode stack and a peeling device removing, after densifying, the treated carrier foil from the SSE layer.

Yet another aspect of the present disclosure relates to a solid-state electrochemical cell. The solid-state electrochemical cell may include a solid-state electrolyte (SSE) layer the first electrode, a treated carrier foil cast onto the SSE layer, the treated carrier foil comprising a surface energy for adhering to the SSE layer, and a conductive layer adjacent the SSE layer to form an electrode stack.

### BRIEF DESCRIPTION OF THE DRAWINGS

The various objects, features, and advantages of the present disclosure set forth herein will be apparent from the following description of embodiments of those inventive concepts, as illustrated in the accompanying drawings. It should be noted that the drawings are not necessarily to scale and may be representative of various features of an embodiment, the emphasis being placed on illustrating the principles and other aspects of the inventive concepts. Also, in the drawings the like reference characters may refer to the same parts or similar throughout the different views. It is intended that the embodiments and figures disclosed herein are to be considered illustrative rather than limiting

FIG. 1 is a diagram illustrating manufacturing a first solid-electrolyte containing electrode laminate using a calender press and peeling device, according to aspects of the present disclosure.

FIG. 2 is a flowchart of a method for manufacturing a solid-electrolyte containing electrode laminate, according to aspects of the present disclosure.

FIG. 3 is a diagram illustrating a defect in manufacturing a solid-electrolyte containing electrode laminate, according to aspects of the present disclosure.

FIG. 4 is a flowchart of a method for manufacturing a solid-electrolyte containing electrode laminate using a treated outer foil layer, according to aspects of the present disclosure.

FIG. 5 is a flowchart of a method for manufacturing a solid-electrolyte containing electrode laminate using a dual laminating process, according to aspects of the present disclosure.

FIG. 6 is a diagram illustrating manufacturing a solid-electrolyte containing electrode laminate using a dual laminating process, according to aspects of the present disclosure.

### DETAILED DESCRIPTION

Lithium-based rechargeable batteries are popular to power many forms of modern electronics and have the capability to serve as the power source for hybrid and fully electric vehicles. State-of-the-art lithium-based rechargeable batteries typically employ a carbon-based anode to store lithium ions, such as a graphite anode. In these anodes, lithium ions are stored by intercalating between planes of carbon atoms that compose graphite particles. Cathodes of such rechargeable batteries may contain transition metal ions, such as nickel, cobalt, and aluminum, among others. Such electrodes have been tailored to confer acceptable performance in modern lithium-ion batteries. However, carbon-based anodes are reaching maturity in terms of their lithium-ion storage.

Traditional electrode manufacturing for lithium-based rechargeable batteries can be a time-consuming and inefficient process. To manufacture a graphite anode, for example, a graphite slurry is produced that includes graphite components, binders, and some kind of solvent that is then applied to a metal foil, such as a copper foil, by a process of extrusion, rolling, or tape-casting, depending on selected process and solvents used. After application, the coated graphite mixture is dried by evaporation of solvents, such as by running the coated slurry through an oven or other drying machine. Cathode construction may occur in a similar manner with an aluminum foil used.

This process for generating a dried electrode sheet may have a high porosity that is detrimental to an efficient operation within a rechargeable battery. Therefore, the sheet is often passed through a calendar press device to reduce the porosity of the materials. The pressed electrode sheet may then be cut into desired lengths. For use in a battery cell (such as a cylindrical cell, prismatic cell, pouch cell, and the like), a stack comprising a separator positioned between the anode sheet and the cathode sheet discussed above is then produced from the separate cathode sheet, anode sheet and separator. Typical separators use some type of polyethylene material with a ceramic coating to separate the anode and the cathode and prevent shorts within the battery. A liquid electrolyte then surrounds and penetrates the produced stack within the battery cell. However, each of the multiple steps of the above process to produce the battery stack may introduce inefficiencies or opportunities for flaws to be introduced in the battery design, resulting in shorter battery life or potential for a short within the battery itself.

Each of the multiple steps of the above process to produce the battery stack may introduce inefficiencies or opportunities for flaws to be introduced in the battery design, resulting in shorter battery life or potential for a short within the battery itself. For example, one or more layers of the battery stack may be quite delicate and may tear or break if handled roughly. Further, the graphite slurry coated onto the metal foil may attach to the foil such that separation of the graphite from the foil may be difficult, particularly without damaging other layers of the battery stack. As such, tremendous care is typically required in the manufacturing and handling of battery electrodes to prevent damaging one or more layers of the electrode stack.

Aspects of the present disclosure involve systems and methods of producing an electrode laminate for a battery that includes a solid-electrolyte separator layer that may replace a conventional separator layer and liquid electrolyte used in conventional liquid electrolyte battery architectures. Further, it has been observed that adhesion between, and/or cohesion of, the various layers of an electrode stack may contribute to physical flaws within the stack during the manufacturing process. As such, aspects of the present disclosure involve utilizing layers, such as an outer carrier foil layer, that provide a surface energy sufficient to prevent separation of the layers of the stack during lamination while allowing for the proper densification of the solid-electrolyte separator layer. In one particular example, a Corona-treated or carbon coated outer foil layer may be used during manufacturing of the electrode stack that provides a sufficient surface energy to adhere to the solid-electrolyte separator layer during the lamination process, while allowing for subsequent peeling of the Corona-treated outer foil from the electrode stack after densification without damaging the remaining layers of the stack. In another particular example, a Corona-treated or carbon coated outer foil layer may be used during manufacturing of the electrode stack that provides a sufficient surface energy to adhere to the electrode layer during the lamination process, while allowing for subsequent peeling of the Corona-treated outer foil from the electrode layer after densification without damaging the electrode layer. The electrode or electrode laminate discussed herein may be utilized in any type of battery or electrochemical cell, including solid, semi-solid, or liquid-based batteries.

In one example, an electrode may comprise a stack of a center electrode layer or layers, a solid-state electrolyte (SSE) layer, and an outer foil layer. In one implementation, the center electrode may include a silicon anode, either for a single sided electrode or for a double-sided electrode. In the double-sided electrode configuration, a copper layer may be between two silicon anode layers such that the electrode stack is arranged in an [Outer foil—SSE—Silicon Anode—Copper—Silicon Anode—SSE—Outer foil layer] stack. In another implementation, the center electrode layer may be a lithium foil and the layers may be arranged in an [Outer foil—SSE—Lithium—SSE—Outer foil layer] stack. In other implementations, the center electrode may be a lithium alloy such as Li—Al (Lithium-Aluminum), Li—Mg (Lithium-Magnesium), Li—In ((Lithium-Indium). The lithium content of the center electrode alloys may be, in some examples, 5% to 99.9%, 10% to 99%, 20% to 98%, or 50% to 95%. In still another implementation, the center electrode may be a cathode comprising conductive materials, such as gold, silver, cadmium, etc. In general, any type of conductive material arranged in one or more layers may be utilized as the center electrode layer for the solid-electrolyte containing electrode.

To laminate the center electrode layer to the SSE layers, the stack may be fed through a calender press device comprising a first hard roller and a second hard roller. There is a gap between the rollers and the stack thickness is larger than the gap prior to calendering. As the stack is fed between the rollers through the gap between the rollers, the rollers exert a force, which may be considered in some instances a compressive force, on the stack to press the layers together, thereby reducing the porosity of the materials within the stack (or increasing the density of the materials), enhancing material contact, and/or causing some layers to bond. Following the calender press, the electrode stack may be fed through a peeling device configured to peel the outer foil layers from the corresponding SSE layers of the electrode stack. The outer foil layer is then directed away from the stack and onto a roller or other collector. After the aluminum layers are peeled, the remaining layers of the electrode stack are collected, and sometimes cut, to be used in an electrochemical cell. As such, the peeling device provides for the removal of the outer foil layer in a roll-to-roll process without applying tension on the delicate inner electrode layers that may damage the layers. In particular, the inner electrode layers may be delicate and prone to tearing when pulled. Thus, through the peeling device, the tension used to move the laminated electrode through the device may be all or mostly be applied to the outer foil layers, protecting the remaining delicate layers of the stack. However, the higher the surface energy of the outer foil layers, the more force may be needed to remove the outer layer from the remaining layers, which may damage the remaining layers. An outer layer with too low of a surface energy, however, may separate from the other layers too early in the manufacturing process, also damaging the remaining layers of the electrode.

In some implementations, therefore, the outer carrier foil may be pre-treated or be comprised of a material that provides a sufficient adhesion to the SSE layer to prevent separation of the outer foil layer from the SSE layer before the outer layer is peeled by the peeling device. Peeling or rippling of the outer foil layer prematurely may cause damage to the electrode stack during the peeling process. In particular, if the outer foil layer is peeled before the stack enters the peeling device, the tension on the remaining layers to move the stack through the peeling device may damage the electrode layers. Thus, ensuring the outer foil layer remains adhered to the corresponding SSE layer until peeled by the peeling device protects the integrity of the manufactured electrode stack. On the other hand, in circumstances in which the outer foil layer is adhered to the corresponding SSE layer too strongly, the SSE layer may be damaged when the outer foil layer is peeled from the SSE layer by the peeling device. To prevent damage to the multiple layers of the electrode stack, the outer foil carrier layer may be configured to remain adhered to the SSE layer during the lamination process, but separable from the SSE layer by the peeling device in a manner that does not damage the remaining layers of the electrode stack when peeled from the SSE layer.

These and other manufacturing systems and methods are described herein for generating a solid-electrolyte containing electrode laminate for use in a battery configuration.

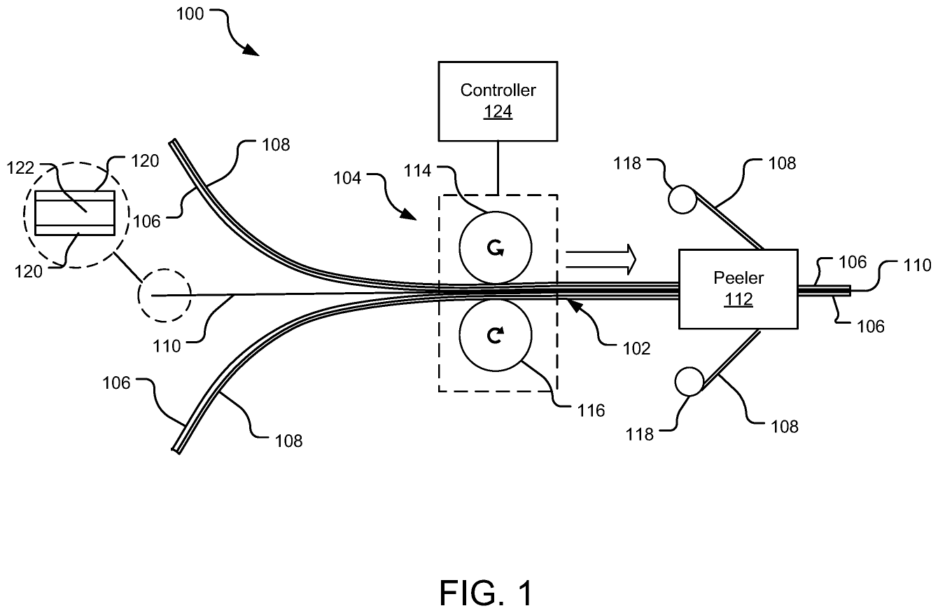

FIG. 1 is a diagram 100 illustrating a system for manufacturing a first solid-electrolyte containing electrode laminate 102 using a calender press device 104 and a peeler 112, according to aspects of the present disclosure. In one implementation, the solid-electrolyte containing electrode laminate 102 may include two separator layers of a composite blend of a solid-state electrolyte (SSE) and a binder. The SSE 106 may be coated as a thin layer on a carrier foil 108. In one example, the carrier foil 108 may be an aluminum foil, although other materials may be used. The center conductor layer 110 may comprise two anode layers 120 separated by a center layer 122. In one implementation, the conductor layer 110 of the electrode stack 102 may comprise a center, carbon-coated copper layer 122 with a silicon composite coating 120 on both sides of the copper layer, although other composites may be used. In another implementation, the center conductor layer 110 may be a single lithium foil layer. In still another implementation, the center conductor layer 110 may be an aluminum foil (for use as a cathode of a battery). Regardless of the composition, the center conductor layer 110 is placed between two facing SSE layers 106. To generate an electrode stack, two different sheets of the SSE 106 on carrier foil 108 may be oriented such that the SSE layers are facing each other with the center conductor layer 110 between the two SSE sheets. In this implementation, the layers forming the electrode stack 102 are fed between the calender press 104 in an Outer foil-SSE-Silicon Anode-Copper-Silicon Anode-SSE—Outer foil stack. As explained in more detail below, the respective rollers of the calender press 104 are spaced apart a distance less than the pre-calendered stack thickness such that pressure on the stack being fed between the calender rollers 114, 116 may reduce the porosity of the materials within the stack (thereby increasing the density of the SSE layers 106), enhance material contact between the layers, and/or cause the SSE layers 106 to laminate or otherwise adhere to the center conductor layer 110. The pressure exerted by the calender rollers on the stack may be adjusted through a calender controller, either manually or automatically, by adjusting the space between the calender rollers. In some instances, the calendering process weakens the SSE bond to the outer carrier foil. The pressure exerted by the calender rollers 114, 116 on the stack may be adjusted through a calender controller 124 configured to adjust the space between the calender rollers.

The SSE layer 106 may comprise, in some implementations, a sulfide-based material that is cast onto an outer metal foil layer 108. The SSE layer 106 may also include a binder solution and/or a solvent prepared in a slurry form. This SSE slurry may be mixed, coated onto the outer foil 108, and dried. In some implementations, each of the SEE layers 106 may be between 30-100 microns thick, although other thicknesses may be used. As noted above, the SSE slurry may be coated onto an outer foil 108 on one side and dried. In some implementation, the outer foil 108 may be between 10-30 microns thick, although other thicknesses may be used. In some implementations explained in more detail below, the outer foil 108 may be pre-treated or otherwise configured to provide a surface energy between an upper threshold and lower threshold to ensure proper adhesion of the SSE layer 106 to the outer foil layer 108 during the laminating process, while also allowing for the outer foil layer to be peeled from the SSE after lamination. In one particular example, the outer foil 108 may be an aluminum foil that is Corona-treated on one or both sides of the layer prior to casting of the SSE 106 onto the outer foil. In another example, the outer foil, or “carrier” foil, layer 108 may be carbon coated to provide the proper adhesion between the layers. Other treatments or compositions of the outer foil layer 108 may be used to ensure an adhesion with the SEE layer 106 between upper and lower threshold values.

To produce the solid-electrolyte containing electrode laminate 102, the layers may be fed through a calender press device 104 in an Outer Foil-SSE-Center Conductor-SSE-Outer Foil layered stack. The calender press 104 may comprise a first roller 114 and a second roller 116 between which the solid-electrolyte containing electrode laminate 102 may be passed. The opposing cylindrical faces of the respective rollers 114, 116 exert a compressive force on the stack 102 to press or laminate the layers together. In one implementation, the pressure exerted on the stack 102 may reduce the porosity of the materials within the stack and cause the layers to bond. For example, the calender press 104 may cause densification of the SSE layers 106 while bonding the SSE layer to the center conductor layer 110. Depending on the amount of pressure exerted, however, the lamination of the stack 102 may cause the adhesion between some layers to lessen, such as the outer foil layers 108 to the SSE layers 106. In some particular examples, the pressure exerted on the stack 102 may range from about 5000 pounds per square inch (psi) to 500,000 psi. This lessening of the adhesion between the layers may cause issues when the outer foil layer 108 is peeled from the stack, as explained in more detail below. In general, the pressure applied to the stack 102 may correlate to a spacing between the first roller 114 and the second roller 116, which may be adjustable by a controller 124. For example, one or both of the calender rollers of the press 104 may be adjustable to increase or decrease the spacing between the rollers 114, 116 based on the overall thickness of the electrode stack or based on the thickness of one or more of the individual layers. The spacing may be input to the controller 124, such as through a user input device connected to the controller, to set the spacing. In another implementation, one or more sensors may be associated with the calender press 104 and provide an output to the controller 124 which may control the spacing in response. For example, the temperature of one or more of the layers of the electrode laminate 102 may affect the densification or adhesion of the layers. Thus, the temperature of the layers may be received from a sensor and the spacing of the rollers 114, 116 may be adjusted based on the received electrode temperature. Alternatively or in conjunction, the temperature of the rollers 114, 116 themselves may be adjusted or altered to change both the amount of densification of the layers of the electrode 102 and/or the adhesion of the layers. Other sensor inputs or other types of inputs may also be received at the controller 124 and used to adjust the calender spacing.

After calendering, the electrode stack 102 may be fed through a peeler 112 or peeling device to remove or peel the outer layer 108 from the stack. The peeler 112 may include an input side into which the electrode stack is fed. Within the peeler 112, the outer layer foil 108 may be peeled from or otherwise removed from the other layers of the stack 102. The peeler 112 may also include an output side in which the electrode stack 102 without the outer carrier layers 108 may exit. In particular, the electrode stack 102 following the peeler 112 may include two SSE layers 106 and the center conductor layer 110 arranged in an [SSE—Center Conductor—SSE] electrode stack configuration. The removed outer foil layers 108 may be peeled from the stack 102 by the peeler 112 and wound around one or more foil collectors 118. More particularly, the collectors 118 may be motorized or otherwise operated to rotate and apply a pulling force on the outer foil layers 108 to peel the layers from the stack 102. The peeler 112 may include structures, such as an upper peeling wedge and a lower peeling wedge, among others, that facilitates the pulling of the foil 108 from the stack 102 in a manner that resists tearing the foil and/or damaging the layers of the stack as the outer foil layers are pulled from the stack. The peeled outer foil layers 108 may, in some instances, be unwound from the collectors 118 and used again in generating other solid-electrolyte containing electrode laminate batches. One particular implementation of the peeler 112 is described in greater detail in co-pending Provisional patent application Ser. No. 18/377,251, entitled “Peeling Mechanism and Method for a Laminated Electrode”, filed Oct. 5, 2023, the entirety of which is incorporated herein. The output electrode stack 102 from the peeler 112 may be utilized as an anode in a solid-state battery or other possible uses.

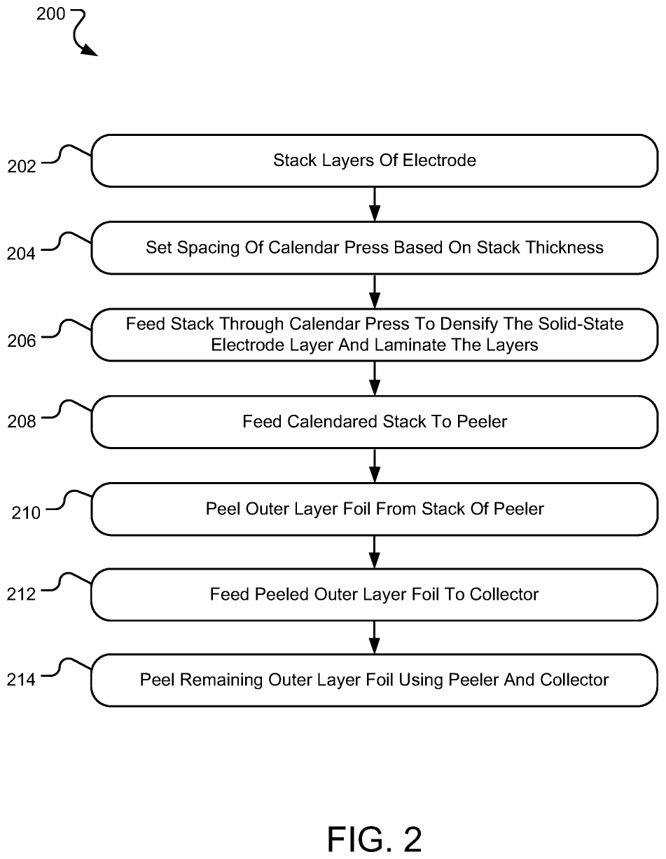

FIG. 2 is a flowchart of a method 200 for manufacturing a solid-electrolyte containing electrode laminate using components of FIG. 1. Beginning at step 202, the layers of the electrode may be stacked in an [Outer Carrier Layer—SSE—Center Conductor—SSE—Outer Carrier Layer] configuration. The stacked configuration may be fed through a calender press 104 to laminate the SSE layers 106 onto the center conductor 110 layer. Thus, at step 204, a spacing of the calender press 104 may be set. In one implementation, the spacing may be manually set by an operator of the press 104. In another implementation, the spacing may be controlled by a calender press controller 124 based on one or more inputs. Further, the spacing of the calender press 104 may be based on the thickness of the stack 102 of materials or on the thickness of any or more of the layers of the stack. At step 206 and following the setting of the spacing of the press 104, the stack 102 may be fed through the calender press for laminating the SSE layers 106 to the center conductor layer 110 and to densify the SSE layers.

At step 208, the calendered electrode stack 102 may be fed to the peeler 112 and, at step 210, the outer layer 108 may be peeled from the stack. In some implementations, the outer layer 108 may be initially peeled from the stack manually to start the peeling process. In other implementations, the peeler 112 may include an edge or other mechanism that begins peeling the outer layer 108 from the stack 102. The peeling of the outer foil layer 108 may occur on both the top outer layer and the bottom layer, or on either the top layer or the bottom layer. In general, although discussed herein for the peeling of an outer foil layer 108 of the stack 102, the operations of the method 200 may apply to either or both of the upper outer foil layer or the bottom foil layer.

At step 212, the peeled outer layer foil 108 may be fed to and wound around a collector 118, such as a collector spool for accumulating the peeled foil from the peeler 112. The feeding of the foil 108 to the collector 118 may be performed manually or through a feeding mechanism that routes the peeled outer layer foil to a collector. At step 214, the peeler 112, as well as the collector 118 in some instances, may be operated to peel the remaining outer foil layer from the calendered stack 102. In particular, the collector 118 may generate tension on the outer foil 108 to pull the foil from the stack 102. The peeler 112 may be configured to gently guide the pulled foil from the stack 102 without tearing the foil or damaging the remaining layers of the stack. As the outer foil layer 108 is peeled, the remaining layers may pass out of the peeler 112 for cutting into appropriate lengths for use in a battery configuration.

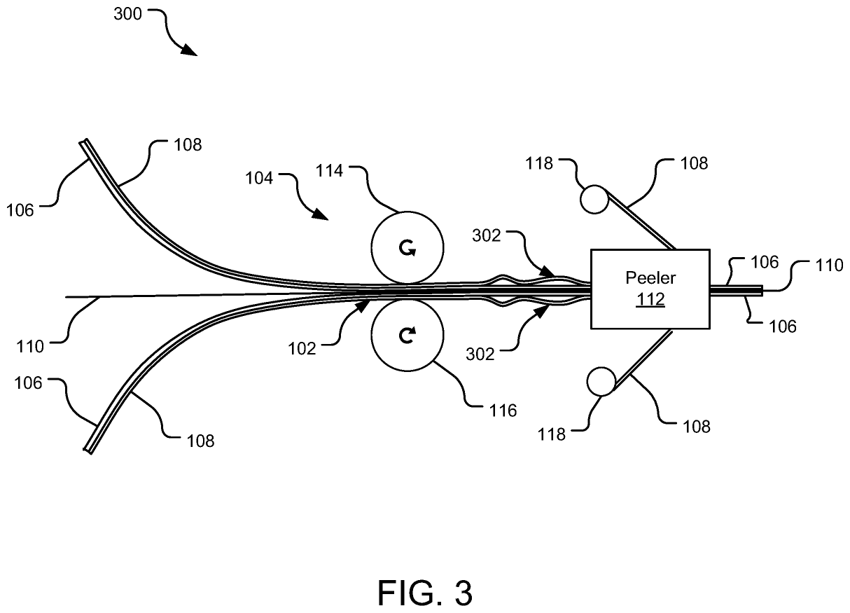

As mentioned above, the calendering of the electrode stack 102 may lessen the adhesion between the outer layer 108 and the SSE layer 106. In particular, the high pressures used by the calender press 104 to densify the SSE layer 106 and/or laminate the SSE layer to the center conductor 110 may reduce the adhesion between the SSE layer and the outer foil 108. FIG. 3 illustrates one possible defect in the manufacturing of a solid-electrolyte containing electrode laminate caused by this reduction in adhesion. The components of the environment 300 of FIG. 3 are the same as described above with reference to FIG. 1. In this instance, if the adhesion between the outer foil layer 108 and the SSE 106 falls below a threshold, the carrier foil may fully delaminate from the SSE layer, resulting in ripples 302 or wrinkles in the stack as the outer foil layer detaches from the SSE layer. When the peeler 112 attempts to peel the outer layer 108 away from the stack 102, the ripples 302 may cause a transfer of the pulling tension from the outer layers to the remaining layers of the stack, potentially damaging the center conductor layer 110 or SSE layer. In particular, a constant peeling pressure may be applied to the outer layer 108 by the collectors 118 that aids in lifting the outer layer away from the stack 102 without damaging the remaining layers while pulling the stack through the peeler 112. However, when the rippled area 302 of the stack is pulled by the collectors 118, the tension along the outer layer 108 is momentarily lowered as there is little adhesive resistance to pulling the outer layer from the stack. At this instant, the tension to keep pulling the stack 102 through the peeler 112 is transferred to the remaining SSE layers 106 and center conductor 110. This increase in tension on the remaining layers may result in cracking or other damage to the layers, reducing the effectiveness of the stack 102 as an electrode of a battery.

In many instances, some reduction in the adhesion of the SSE layer 106 to the outer carrier layer 108 may be desired. For example, if the adhesion of the outer carrier layer 108 to the SSE layer 106 is greater than the cohesion of the component of the SSE layer, the SSE layer may be damaged when the outer layer is peeled by the peeler 112, possibly breaking the SSE layer or pulling a portion of the SSE layer with the peeled carrier layer. This may also occur if the adhesion between the SSE layer 106 and the carrier layer 108 is greater than the adhesion between the SSE layer and the electrode layer 110. As such, an outer carrier layer 108 may be selected for use in the manufacturing of the electrode stack 102 that has an adhesion threshold to the SSE layer 106 to remain adhered to the SSE layer post calendaring, but can be peeled from the SSE layer by the peeler 112 without damaging the underlying SSE.

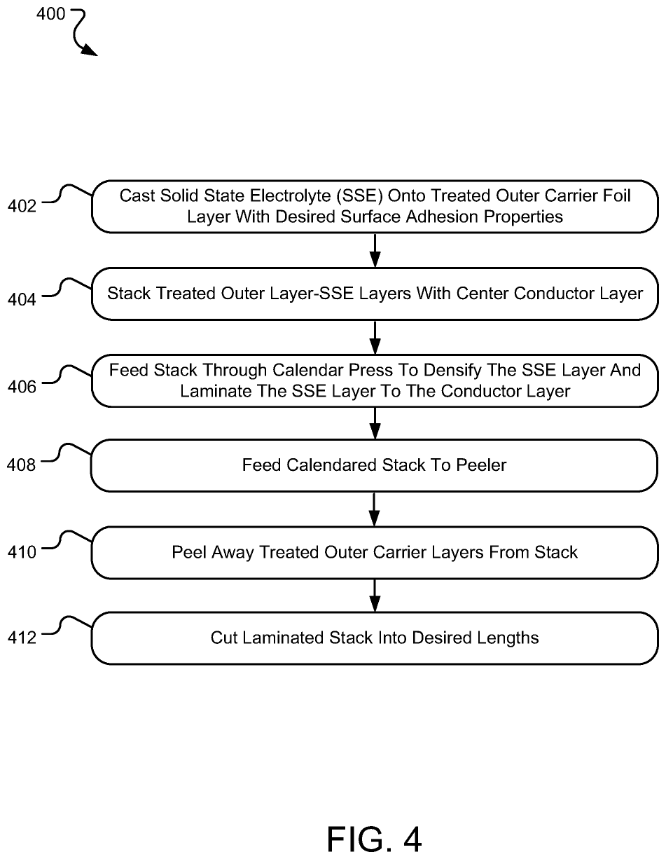

FIG. 4 illustrates a method 400 for manufacturing a solid-electrolyte containing electrode laminate using a treated outer foil layer. Some of the operations of the method 400 of FIG. 4 are similar to those above with reference to FIG. 2. However, in this instance, a treated outer carrier foil layer may be used that includes a surface energy or adhesion to the SSE layer that allows for the carrier foil to adhere to the SSE layer after densification of the electrode stack but can also be peeled from the SSE layer without damaging the remaining SSE layer. As such, in operation 402, the SSE layer 106 may be cast onto a pre-treated carrier foil 108 with the desired surface adhesion properties. For example, the surface energy of the treated carrier foil may be greater than 25 dynes/cm. In another example, the surface energy of the treated carrier foil may be greater than 30 dynes/cm or greater than 35 dynes/cm. In addition, a surface roughness (roughness area (Ra)) of the carrier foil may be less than 1 um, less than 0.75 um, or less than 0.5 um. In one implementation, the carrier foil 108 may be Corona-treated before casting. A Corona treatment is a surface modification technique that corona discharge from the application of high voltage to the surface to alter one or more properties of the surface. Such a process may change the surface energy of the material. In this example, the carrier foil 108 may therefore undergo a Corona treatment to alter the surface energy of the carrier foil. In another implementation, the outer carrier layer 108 may be carbon-coated to provide the sufficient adhesion of the outer layer to the case SSE layer 106. It is contemplated that other types of metal foils, such as polymer-based foils/sheets, may be used as the carrier foil provided the selected material has sufficient surface adhesion to the SSE layer.

At operation 404, the casted SSE layer 106 on the treated outer layer 108 may be stacked with a center conductor layer 110. In some instances, a casted SSE layer 106 on the treated outer layer 108 may be stacked on both sides of the center conductor layer 110 to create an [Outer foil—SSE—Center Conductor—SSE—Outer foil] stack. As explained above, the center conductor layer 110 may comprise one or more layers, such as a copper center coated with silicon on both sides. In other examples, the center conductor layer 110 may be a lithium foil, aluminum foil, or a coated foil, such as an aluminum foil coated with a cathode active material containing composite. At operation 406, the constructed electrode stack may be fed through a calender press 104 to densify the layers of the stack 102 (particularly the SSE layer 106), laminate the SSE layer to the center conductor layer 110, and reduce the adhesion of the outer foil layer 108 to the SSE layer. The spacing of the calender press 104 may be such that each of the above goals are achieved within the stack without fully separating the outer foil layer 108 from the SSE layer 106 to cause ripples 302 in the outer layer. A spacing of the calender press 104 may be controlled through a controller 124, either in response to one or more inputs to the controller or through signals provided by sensors of the laminating environment 100.

At operation 408, the calendered electrode stack 102 may be fed to the peeler 112 and, at step 410, the outer layer 108 may be peeled from the stack, as described above. Due to the surface adhesion properties of the treated outer carrier foil layer 108, the outer layer may remain adhered to the SSE layer 106 as the stack is fed to the peeler 112. The surface adhesion properties of the treated outer carrier foil layer 108 may also be such that the outer layer may be peeled from the SSE layer 106 by the peeler 112 without damaging the SSE layer or the center conductor layer 110. In this manner, an exerted pressure on the stack 102 by the calender press 104 may be high enough to densify the SSE layer 106 without separating the outer carrier foil layer 108 from the SSE layer prior to peeling. At operation 412, the peeled, laminated stack may be cut into desired lengths for use in a battery configuration.

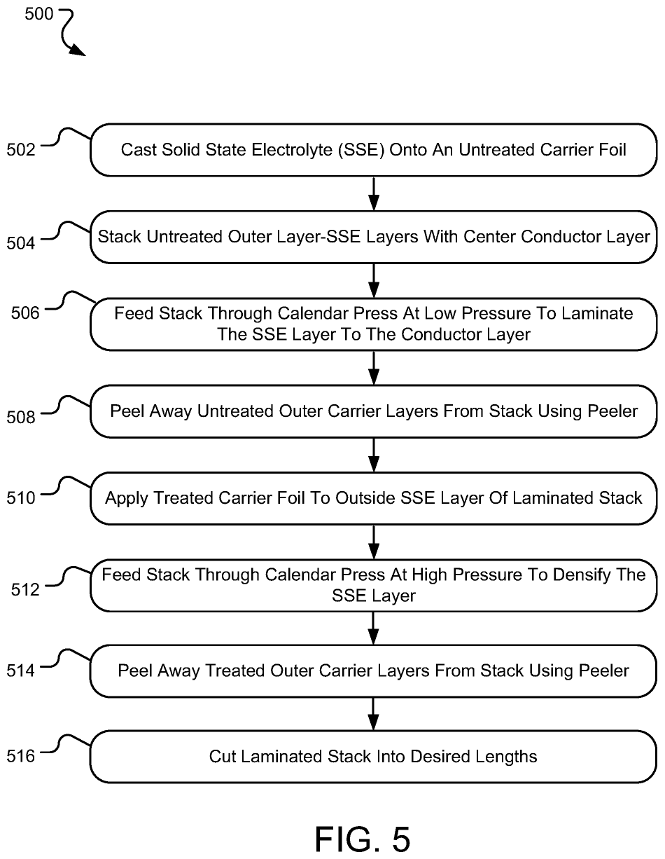

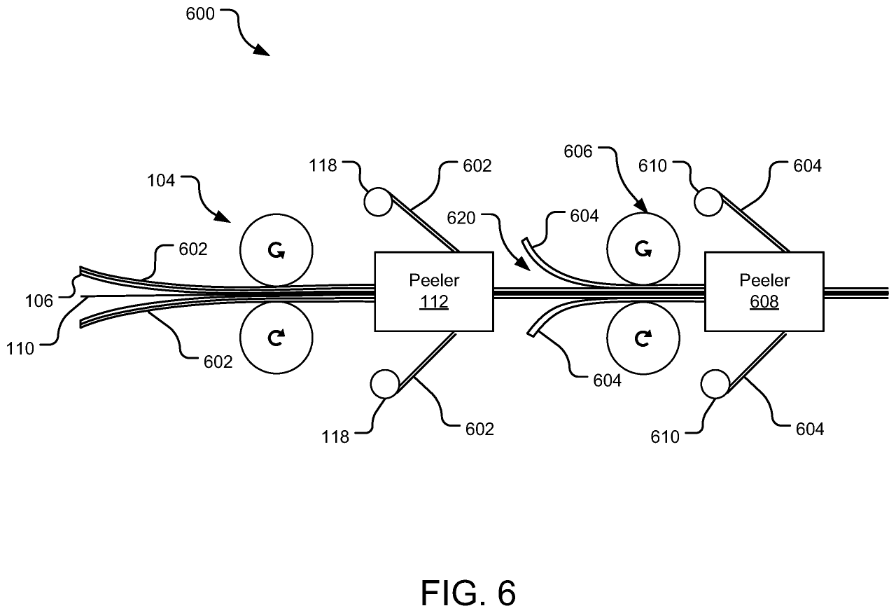

FIG. 5 is a flowchart of a method 500 for manufacturing a solid-electrolyte containing electrode laminate using a dual laminating process, according to aspects of the present disclosure. The operations of the method 500 are discussed below with reference to the manufacturing environment 600 of FIG. 6. Beginning at operation 502, the SSE layer 106 as discussed above may be cast onto an untreated carrier foil layer, illustrated as layer 602 of the environment 600. An untreated carrier foil layer 602 may be a metal layer that does not have adhesion properties within the desired tolerance to remain adhered to the SSE layer 106 at high pressures. Thus, at operation 504, the cast untreated outer layer-SSE layer may be stacked with a center conductor layer 110, either on one side or both sides of the center conductor. The cast untreated outer layer-SSE layer may be stacked with the center conductor such that the SSE layer abuts the center conductor.

At operation 506, the electrode stack may be fed through a calender press 104. The spacing of the calender press 104 may be set to apply sufficient pressure to laminate the SSE layers 106 to the center conductor 110, but less than a pressure at which the outer layer 602 may start to ripple or separate from the SSE layer 106. At such a pressure, the SSE layers 106 may not densify to a desired level for use of the electrode in a battery configuration. Further, the pressure applied by the calender press 104 to the stack may be high enough for the untreated outer foil layer 602 to delaminated or partially separate from the corresponding SSE layer 106, but not too high such that the lamination of the SSE layers 106 to the center conductor 104 is not damaged.

At operation 508, the untreated outer layer 106 may be peeled from the stack by the peeler 112 and wound around a collector 118, as described above. Through this process, the stack 102 may comprise a laminated [SSE—center conductor—SSE] stack (for a double-sided anode) or a laminated [SSE—center conductor] stack (for single-sided anode). Further, the center conductor may be a center foil conductor or an anode/center foil/anode, as also described above. However, although the laminated stack includes the proper layers in the correct arrangement for use in a battery configuration, the SSE layers 106 of this stack may not be sufficient densified for such use due to the relatively small pressure applied to the stack by calender press 104. Therefore, at operation 510, a treated foil 604 may be applied as outer layers to the laminated stack. In one example, a Corona-treated foil may be applied adhered to an outer surface of the laminated SSE layer 106. In another example, the treated foil 604 may be a carbon-coated foil. The treated foil 604 may be adhered to the SSE layer 106 of the laminated stack as a part of an assembly line process for manufacturing the laminated electrode stack, as illustrated at location 620 of FIG. 6. Thus, in one example, the treated foil 604 may be unwound from a roller and applied to the outer surface of the SSE layer 106 as the laminated stack exits the peeler 112.

Following application of the treated foil 604 to the outer surface, the laminated stack with the treated foil may be passed through a calender press, such as second calender press 606, in operation 512. The pressure applied to the stack by the second calender press 606 may be higher than the pressure applied by the first calender press 104. This second higher pressure may densify the SSE layers 106 to a desired level for use in a battery configuration. In one example, the pressure of the second calender press 606 may correspond to a spacing between the rollers of the calender press, which may be set by a controller or manually by an operator of the calender press. In some embodiments, the laminated stack with the treated outer layer 604 may be fed back through the first calender press 104 after the spacing of the first calender press has been adjusted to apply the higher pressure to the stack with the treated outer foil 604.

The pressing of the laminated stack at the higher pressure may have a similar effect on the stack as described above. In particular, the higher pressure may densify the SSE layers 106 to a desired level. Further, because of the outer foil 604 is treated to adhere to the SSE layer through the densification process, the outer layer remains adhered to the SSE layer after the second calender press 606. The higher pressure of the second calender press 606 may also further laminate the SSE layers 106 to the center conductor layers 110. After the densification of the SSE layers 106 by the second calender press 606, the laminated stack may be provided to a second peeler 608 to peel off the treated outer layer 604 at operation 514. As described above, the treated outer layer 604 may have sufficient surface energy to adhere to the corresponding SSE layer 106 through the densification process while also allowing for the outer foil to be peeled from the stack by the second peeler 608 without damaging the SSE layer. Following the peeling of the treated outer layer 604, the laminated/densified stack may be cut into appropriate lengths for use in one or more battery configurations.

Various modifications and additions can be made to the exemplary embodiments discussed without departing from the scope of the present invention. For example, while the embodiments (examples or aspects) described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” or similarly “in one aspect”, “in one example” or the like in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given above. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Various features and advantages of the disclosure are set forth in the description above, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the description and appended claims or can be learned by the practice of the principles set forth herein.

What is claimed is:

1. A method for manufacturing a battery electrode, the method comprising:
casting a solid-state electrolyte (SSE) layer onto a treated carrier foil, the treated carrier foil comprising a surface energy adhering the SSE layer to the treated carrier foil;
layering a conductive layer adjacent to the first SSE layer to form an electrode stack; and
densifying the SSE layer by applying a densifying pressure to the SSE layer, wherein the surface energy retains the adherence of the SSE layer to the treated carrier foil following the densifying of the electrode stack.

2. The method of claim 1, wherein the treated carrier foil comprises a Corona treatment, the Corona treatment generating the surface energy of the treated carrier foil.

3. The method of claim 1, wherein the treated carrier foil comprises a carbon-coating treatment, the carbon-coating treatment generating the surface energy of the treated carrier foil.

4. The method of claim 1, wherein the conductive layer comprises a silicon anode layer adjacent the SSE layer on a surface opposite the treated carrier foil.

5. The method of claim 1, wherein the conductive layer comprises a lithium foil layer.

6. The method of claim 1 further comprising:
casting a second SSE layer onto a second treated carrier foil; and
layering the second SSE layer adjacent to the conductive layer on an opposite side of the SSE layer to form the electrode stack.

7. The method of claim 6, wherein the conductive layer comprises a first silicon anode layer, an electrically conductive layer, and a second silicon anode layer adjacent the electrically conductive layer opposite the first silicon anode layer.

8. The method of claim 1, wherein densifying the SSE layer comprises passing the electrode stack through a pressing device at the densifying pressure laminates the SSE layer to the conductive layer.

9. The method of claim 8, wherein the pressing device is a calender press comprising a first roller and a second roller, the first roller oriented above the second roller and separated by a pressing gap corresponding to the densifying pressure.

10. The method of claim 1, wherein densifying the SSE layer lowers a first adhesion property between the SSE layer and the carrier foil and increases a second adhesion property between the SSE layer and the conductive layer.

11. The method of claim 10, wherein the surface energy of the treated carrier foil is less than the adhesion property between the SSE layer and the conductive layer to provide for removing, using a peeling device, the treated carrier foil from the SSE layer as the SSE layer remains adhered to the conductive layer via the second adhesion property.

12. A method for a laminated electrode, the method comprising:
layering a first side of a solid-state electrolyte (SSE) layer adjacent to a conductive electrode as an electrode stack, wherein the SSE layer is cast onto a carrier foil on a second side opposite the first side;
laminating the SSE layer to the conductive electrode by applying a laminating pressure to the electrode stack;
removing the carrier foil from the second side of the SSE layer;
layering the second side of the SSE layer with a treated carrier foil comprising a surface energy for adhering the SSE layer to the treated carrier foil; and
densifying the SSE layer by applying a densifying pressure to the electrode stack, wherein the densifying pressure is greater than the laminating pressure.

13. The method of claim 12 further comprising:
removing the treated carrier foil from the second side of the SSE layer after densifying the SSE layer.

14. The method of claim 12, wherein the treated carrier foil layer comprises a Corona treatment on a surface of the foil adjacent to the SSE layer.

15. The method of claim 12, wherein the treated carrier foil comprises a carbon-coating treatment on a of the foil adjacent to the SSE layer.

16. A solid-state electrochemical cell comprising;
a solid-state electrolyte (SSE) layer the first electrode;
a treated carrier foil cast onto the SSE layer, the treated carrier foil comprising a surface energy for adhering to the SSE layer; and
a conductive layer adjacent the SSE layer to form an electrode stack.

17. The solid-state electrochemical cell of claim 16, wherein the treated carrier foil comprises a Corona treatment, the Corona treatment generating the surface energy of the treated carrier foil.

18. The solid-state electrochemical cell of claim 16, wherein the treated carrier foil comprises a carbon-coating treatment, the carbon-coating treatment generating the surface energy of the treated carrier foil.

19. The solid-state electrochemical cell of claim 16, wherein the conductive layer comprises a silicon anode layer adjacent the SSE layer on a surface opposite the treated carrier foil.

20. The solid-state electrochemical cell of claim 16, wherein the conductive layer comprises a lithium foil layer.

21. The solid-state electrochemical cell of claim 16 wherein the surface energy is greater than 25 dyne/cm and a surface roughness of the treated carrier foil is less than 1 um.

22. A method for manufacturing a battery electrode, the method comprising:
coating an electrode layer onto a carrier foil;
layering a treated carrier foil on the coated electrode layer, the treated carrier foil comprising a surface energy to adhere to the electrode layer; and
densifying the layered electrode layer by applying a densifying pressure to the layered electrode layer, wherein the surface energy retains the adherence of the electrode layer to the treated carrier foil following the densifying of the layered electrode layer.

23. The method of manufacturing a battery electrode of claim 21 wherein the surface energy is greater than 25 dyne/cm.

24. The method of manufacturing a battery electrode of claim 21 wherein the treated carrier foil has a surface roughness of less than 1 um.
